(19) United States
(12) Patent Application Publication
(10) Pub. No.: US 2010/0088736 A1
(43) Pub. Date: Apr. 8, 2010

(54) ENHANCED VIDEO PROCESSING FUNCTIONALITY IN AUXILIARY SYSTEM

(76) Inventor: Peter D. Besen, North Andover, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/574,281

(22) Filed: Oct. 6, 2009

Related U.S. Application Data
(60) Provisional application No. 61/195,379, filed on Oct. 7, 2008.
(60) Provisional application No. 61/207,506, filed on Feb. 13, 2009.

(51) Int. Cl. H04N 7/173; H04N 7/26

(52) U.S. Cl. 725/119; 375/240.25; 348/441; 375/E07.027

(57) ABSTRACT

According to example configurations herein, a downstream video processor operates in conjunction with an existing consumer-operated tuner system. The downstream video processor system can be an add-on system disposed in a communication link between the consumer-operated tuner system and a remote video playback device such as a hi-definition television. In lieu of processing video data locally in the set-top box, the consumer-operated tuner system can transmit the video data to the downstream video processor for processing. The downstream video processor in the communication link can be configured to provide enhanced video processing services (e.g., better resolution, higher frame rate rates, enhanced signal to noise ratio, enhanced color quality, 3-D graphics, etc.) with respect to video processing services supported by an upstream video decoder in the consumer-operated tuner system.

### RELATED APPLICATIONS

This application is related to and claims the benefit of earlier filed U.S. Provisional Patent Application Ser. No. 61/195,379, entitled “Enhanced Method and Device for enabling new functionality in Video Device Applications,” filed on Oct. 7, 2008, the entire teachings of which are incorporated herein by this reference.

This application is related to and claims the benefit of earlier filed U.S. Provisional Patent Application Ser. No. 61/207,506, entitled “Enhanced Method and Device for enabling new functionality in Video Device Applications,” filed on Feb. 13, 2009, the entire teachings of which are incorporated herein by this reference.

### BACKGROUND

Conventional technology has made it possible to more quickly and efficiently convey information to corresponding subscribers. For example, in the cable network space, digital cable now offers a multitude of channels to subscribers for receiving different types of streamed data content for playback on a respective television.

According to conventional cable technology, respective subscribers typically use so-called set top box devices in their homes to receive encoded digital information transmitted from a corresponding cable company. In many instances, a respective set top box receives a number of standard data streams on each of multiple different channels and decodes a single encoded data stream for playback on a display screen.

Satellite dish technology works in a similar manner except that the signals are received from a satellite rather than from a so-called cable company as discussed above. A set-top box associated with the satellite dish decodes the received signals for playback.

Upon receipt of encoded data, the set top box decodes the received data stream. Once decoded, a respective set top box in a viewer's home typically drives a corresponding television system with an appropriate “rasterized” signal of decoded data derived from the selected channel. Accordingly, a television viewer is able to view a corresponding television program of moving pictures transmitted by the cable company.

The encoded data received at the set-top box is typically compressed video. Conventional video compression refers to a method of reducing a number of data bits required to represent digital video images. As is known, video compression can be based on a combination of spatial image compression and temporal motion compensation. Such compression is useful because bandwidth for transmitting data from a server to a target destination such as a set-top box is often limited.

Conventional set-top boxes typically include decoder circuitry as mentioned above to convert a received signal into a playback signal used to drive a respective playback device such as a display screen. The decoder circuitry is typically deployed to convert the compressed video received from a server into a format that is suitable for playback on a display screen.

Display screen technology and other playback type of devices such as hi-definition television screens have rapidly evolved over the last few years to provide higher quality playback experiences for viewers. One parameter of playback quality is playback resolution. In general, the price of display screens supporting 1080p playback resolution (e.g., progressive scanning of 1080 vertical lines of pixels) has dropped considerably such that most consumers are now willing to spend the modest amount of extra money needed to upgrade to a display screen supporting 1080p playback resolution rather than purchase one that merely supports 720p playback resolution (e.g., progressive scanning of 720 vertical lines of pixels).

### BRIEF DESCRIPTION

Conventional applications such as those as discussed above can suffer from a number of deficiencies. For example, playback devices such as hi-definition televisions that provide higher playback quality are becoming more and more affordable. Conventional set-top boxes may not be able to produce a respective high quality signal supported by the playback device. For example, most homes are equipped with a conventional set-top box that is capable of, at best, providing a relatively low picture quality. As an example, most conventional cable television servers transmit compressed data that supports a 720p playback resolution even though a television in a consumer's home may support display of a 1080p playback resolution.

One way to provide higher quality playback resolution for the consumer is to replace old set-top box hardware with new set-top box hardware capable of providing enhanced picture quality as supported by the new, now affordable display screens. A downside to such an approach is that redesign and replacement of the old set-top boxes can be costly. That is, the conventional set-top box as discussed above would have to be replaced in order to produce a 1080p playback signal.

Certain embodiments herein are directed to providing enhanced picture quality without having to replace and/or redesign old set-top boxes.

For example, in contrast to conventional system and methods, embodiments herein include an enhanced video processing system that operates in conjunction with an existing, conventional set-top box. The video processing system can be an add-on, video processing system disposed in a communication link or cable between the existing conventional set-top box and a remote video playback device. The conventional set-top box can be reconfigured to operate in conjunction with a video processing system in the communication link.

The video processing system disposed in the communication link can be configured to provide enhanced video decoding and/or processing services with respect to video decoding and/or processing services supported in the conventional set-top box. For example, according to one embodiment, the communication link and corresponding video processing services therein can provide enhanced image quality (e.g., better resolution, higher frame rate rates, enhanced signal to noise ratio, enhanced color quality, 3-D graphics, etc.) for playback at the playback device.

More specifically, as mentioned above, a conventional set-top box may be able to provide standard decoding services such as 720p for converting and displaying content on a display screen. However, the display screen may support a higher playback quality than can be provided by decoding provided in the conventional set-top box. To provide enhanced decoding and/or image processing capabilities, as mentioned above, embodiments herein include disposing an auxiliary or supplemental video processing system such as a video decoder system at a location in between the set-top box and the display screen. Accordingly, in one embodiment, rather than provide decoding services only in the set-top box, the set-top box can be configured to forward encoded data to a downstream video decoder system residing in between the set-top box and the display screen.

An example system according to embodiments herein can include an input, a video processing system, and an output. The input of the video processing system in the communication link can be configured to receive video data (e.g., compressed video data, encoded data, etc.) outputted from a conventional set-top box. The conventional set-top box can be configured to receive the video data from a server (e.g., cable television server) over a network. The conventional set-top box system enables selection of encoded content (e.g., from multiple television channels) to be transmitted to the video processing system in the communication link for playback of corresponding content on a remote playback device such as a display screen. More specifically, according to one embodiment, to support playing back of selected, encoded content, a video processing system in the communication link can be configured to decodea video stream received from the conventional set-top box. Subsequent to decoding by the video processing system, the output of the video processing system in the communication link transmits the decoded video data to the playback device for playback. By way of a non-limiting example, the output can transmit a playback signal to the playback device according to the HDMI transmission protocol.

These and other more specific embodiments are disclosed in more detail below.

The embodiments as described herein are advantageous over conventional techniques. For example, the downstream processing system in the communication link as discussed above can provide enhanced processing capabilities without requiring replacement of a conventional set-top box.

It is to be understood that the system, method, apparatus, etc., as discussed herein can be embodied strictly as hardware, as a hybrid of software and hardware, or as software alone such as within a processor, or within an operating system or a within a software application. Example embodiments of the invention may be implemented within products and/or software applications such as those developed or manufactured by Immedia Semiconductor of Andover, Mass., USA.

As discussed above, techniques herein are well suited for use in video and audio processing applications. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where appropriate, that each of the concepts can optionally be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

FIG. 1 is an example diagram of a data distribution environment according to embodiments herein.

FIG. 2 is an example diagram illustrating a consumer-operated tuner system, a communication link, and playback device according to embodiments herein.

FIG. 3A is an example diagram illustrating a video processor system according to embodiments herein.

FIG. 3B is an example diagram illustrating a video processor system according to embodiments herein.

FIG. 4 is an example diagram illustrating a video processor system according to embodiments herein.

FIG. 5 is an example diagram illustrating a video processor system according to embodiments herein.

FIG. 6 is an example diagram illustrating inclusion of a video processor in a set-top box according to embodiments herein.

FIG. 7 is an example diagram illustrating various ways of overlaying graphics according to embodiments herein.

FIGS. 8-10 are flowchart illustrating example methods supporting enhanced processing services according to embodiments herein.

FIG. 11 is an example architecture for implementing a video processor system in a communication link according to one embodiment.

### DETAILED DESCRIPTION

According to embodiments herein, a downstream video processing system in a communication link can operate in conjunction with existing set-top box hardware operated by a consumer. For example, the downstream video processing system according to embodiments herein can be part of an “add-on” system linking the existing set-top box and a remote video playback device such as a hi-definition television.

In lieu of being required to process all encoded video data locally in the set-top box, the set-top box can transmit encoded video data to the downstream video processing system for processing instead. The downstream video processing system in the communication link can be configured to receive and process the encoded video data to provide enhanced video processing services with respect to video processing services supported by the set-top box to produce a higher quality playback signal (e.g., better resolution, higher refresh frame rates, enhanced signal to noise ratio, enhanced color quality, 3-D video, supplemental graphics, etc.).

Note that embodiments herein are not limited to providing enhanced decoding services. The downstream video processor in the communication link can be configured to provide any type of enhanced data and/or image processing services. Accordingly, a consumer environment can be configured with enhanced video processing functionality merely by installing a downstream video processor in the communication link between the set-top box and the remote display screen.

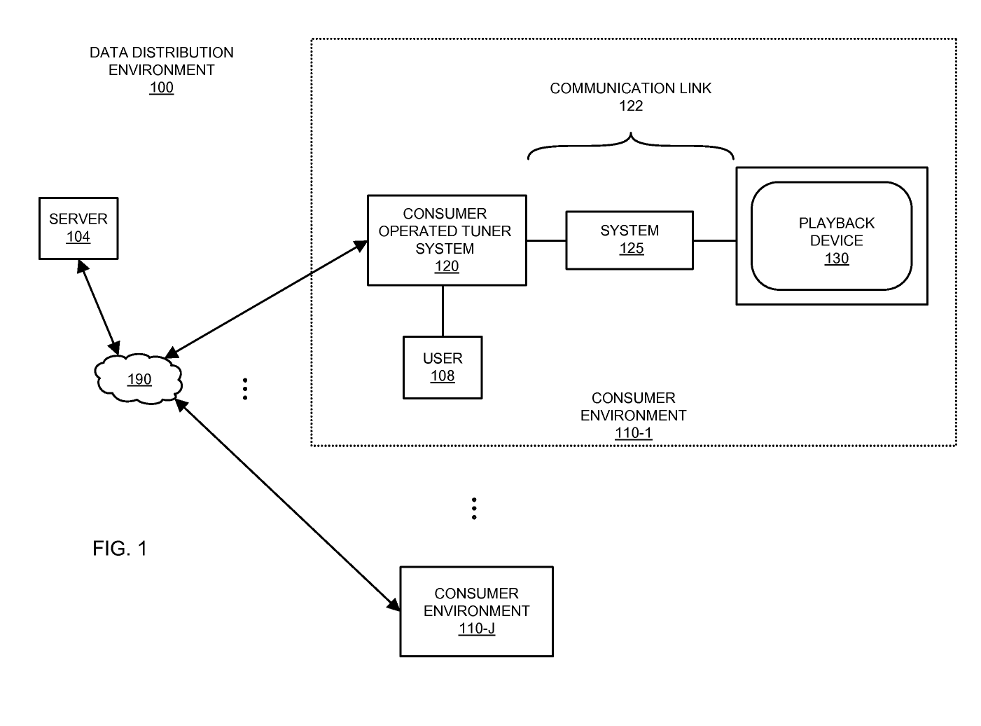

Now, more specifically, FIG. 1 is an example diagram of data distribution environment 100 including a communication link 122 that provides enhanced signal processing functionality according to embodiments herein.

Data distribution environment 100 includes at least one server 104, network 190, and consumer environments 110 (e.g., consumer environment 110-1, . . . , consumer environment 110-J).

Each consumer environment 110-1 such as a household can include a consumer-operated tuner system 120 (e.g., a conventional set-top box), a user 108 (or multiple users), system 125, and a respective playback device 130. As described herein, system 125 can be configured to provide connectivity as well as provide enhanced processing functionality over conventional methods.

As its name suggests, server 104 (e.g., service provider) can be any type of system capable of serving (e.g., delivering and distributing) data throughout network 190 to one or more target destinations such as consumer environments 110. Note that server 104 in FIG. 1 is a logical representation and can include one or more servers located in the same or different locations of network 190 to provide different types of content to one or more target destinations.

Depending on the embodiment, server 104 can be configured to simultaneously send the same encoded data to multiple different destinations or send encoded data only to a single consumer environment 110.

In one embodiment, during operation, server 104 distributes or makes available one or more channels of content to respective consumer-operated tuner systems 120 in consumer environments 110. By way of a non-limiting example, and as mentioned above, the data distributed to consumer environments 110 can be any type of data or content such as compressed video data, compressed audio data, etc. As will be discussed later in this specification, consumer environments 110 equipped with a respective communication link 122 as shown in FIG. 1 can produce higher quality images based on processing provided by system 125 in the communication link 122.

Server 104 can be configured to provide any type of data distribution services. For example, in one example embodiment, server 104 represents a cable-based server configured to disseminate cable television programs, on-demand video, etc., to respective subscribers.

In other embodiments, server 104 can be a web-based server configured to deliver data over network 190 (e.g., a packet-switched network) to one or more target destinations.

In yet other embodiments, server 104 represents a satellite system that delivers content over a wireless connection (e.g., network 190) to consumer environments 110. In this latter embodiment, a respective consumer environment can be equipped with a satellite dish to receive the wireless signals emanating from server 104.

Consumer-operated tuner system 120 (e.g., satellite set-top box, cable set-top box, etc.) present in a consumer environment 110 such as a home enables a respective user 108 to receive information, data, content, control signals, etc., from server 104. As mentioned above, data can be distributed throughout network 190 in a number of different ways. Thus, a configuration of a respective consumer-operated tuner system 120 may vary depending on the type of server 104 distributing respective content (e.g., data as discussed above). For example, consumer-operated tuner system 120 can be a modified conventional set-top box for receiving data from a satellite, cable television server, web-server, etc., depending on the application.

In one embodiment, a user 108 of consumer-operated tuner system 120 selects content to be displayed on playback device 130. Thus, according to one embodiment, the consumer-operated tuner system 120 can reside in a consumer environment 110 in which a respective consumer such as user 108 operates the consumer-operated tuner system 120 to select one or more video data streams for playback by the playback device 130.

In one embodiment, a playback signal generated by system 125 is uncompressed data defining settings of pixels to be displayed on a display screen.

Although the user 108 can select content in any suitable manner, by way of a non-limiting example, as is known according to conventional methods, the user 108 can select the content from a list of content titles, television channels, etc. A format of the received content may vary depending on a configuration of the consumer-operated tuner system 120. In certain cases, system 125 may need to be notified as to the type (e.g., compression format) of content it receives from consumer-operated tuner system 120.

Handshaking between system 125 and the consumer-operated tuner system 120 can be used to notify the consumer-operated tuner system 120 of the different services supported by the system 125 disposed in communication link 122. For example, subsequent to receiving messages from system 125 of the different services or functions it supports, the consumer-operated tuner system 120 can notify server of a presence of the system 125 and different services supported by system 125. In one embodiment, the sever 104 may forward different types of content to consumer-operated tuner system 120 depending on the different supported services supported by system 125.

Handshaking can include receiving authorization information from the server 104 and forwarding the authorization information from consumer-operated tuner system 120 to system 125 to enable system 125 to perform enhanced processing as described herein.

As shown, consumer environment 110-1 includes system 125 in communication link 122 to provide enhanced processing services. As previously discussed, conventional methods require that received data (e.g., compressed video data) be decoded by a conventional set-top box and transmitted on a “passive” flexible cable to a playback device 130. In contrast, the communication link 122 according to embodiments herein can include system 125 for providing enhanced video processing services.

Note that a portion of communication link 122 can include one or more flexible cables to provide flexible connectivity between the consumer-operated tuner system 120 and system 125 as well as provide flexible connectivity between system 125 and the playback device 130. For example, system 125 can reside in a housing to protect system 125 from damage. As discussed later in this specification, communication link 122 can include a first segment of cable to connect system 125 to consumer-operated tuner system 120. Communication link 122 can include a second segment of cable to connect system 125 to playback device 130.

In contrast to conventional methods, one embodiment herein is directed to a system 125 enabling existing video processing devices in consumer environment 110-1 to be upgraded to support increased functionality without having to replace a consumer-operated tuner system 120. For example, as will be discussed in more detail below and in contrast to conventional methods, one embodiment herein includes transmitting the compressed content from the consumer-operated tuner system 120 on, for example, an HDMI interface or in an HDMI format to a downstream processor in communication link 122. During operation, a video processor in the communication link 122 creates a playback signal based on the received content. In one embodiment, the video processor in communication link 122 can transmit decoded content in HDMI format to the playback device 130.

Note that the HDMI format and format have been presented by way of a non-limiting example only and that connectivity can be provided by any suitable format supporting transmission of content.

More specifically, by way of a non-limiting example, embodiments herein can be used to increase quality of video, audio, etc., played back on a playback device 130 such as a television, sound system, etc. The system 125 can be configured to support new compression technology that is not supported by in conventional hardware and/or software in the consumer-operated tuner system 120. As will be discussed later in this specification, embodiments herein include modifying a conventional set-top box to support forwarding of compressed or data to system 125 for processing.

One way that data distribution environment 100 might operate according to embodiments herein is as follows:

1. The consumer-operated tuner system 120 can receive content from one or more sources over network 190. The output of consumer-operated tuner system 120, which normally is connected directly to playback device 130 via a passive cable, is instead connected to playback device 130 via communication link 122.

2. When the consumer-operated tuner system 120 performs decoding, system 125 in communication link 122 can be operated in a “pass-thru” mode in which the signal generated by the consumer-operated tuner system 120 is passed directly to the playback device 130 without further decoding by system 125. As an alternative to a pass-thru mode, system 125 can be configured to providing any type of video processing such as upscaling or other enhanced processing services as discussed herein.

3. When the consumer-operated tuner system 120 is directed to perform functionality which it does not support locally in consumer-operated tuner system 120, the consumer-operated tuner system 120 passes the encoded data to the system 125 for processing such that system 125 processes the encoded data and outputs processed video data to the playback device 130.

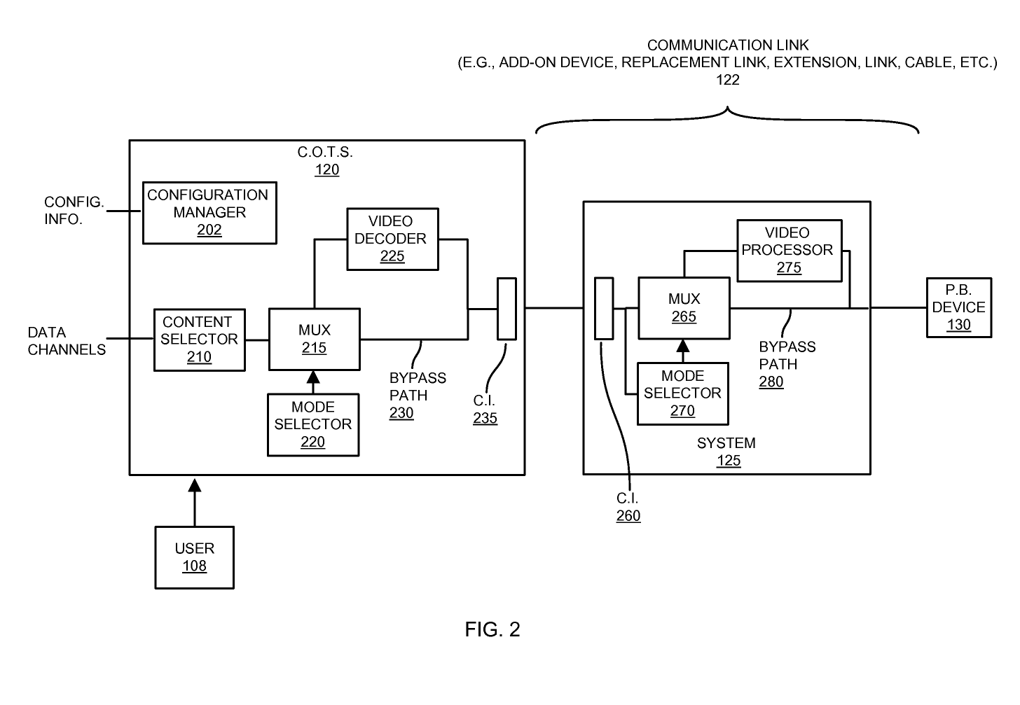

FIG. 2 is an example diagram illustrating more specific details of a consumer-operated tuner system 120 and corresponding system 125 according to embodiments herein.

As shown in the embodiment of FIG. 2, the consumer-operated tuner system 120 can include a configuration manager 202. The configuration manager 202 can be configured to receive software, firmware, configuration information, etc., from the server 104 or other source to configure functionality provided by the consumer-operated tuner system 120.

The consumer-operated tuner system 120 can be configured to perform operations not supported by conventional set-top boxes. For example, the consumer-operated tuner system 120 can be configured to include functionality to enable the consumer-operated tuner system 120 to switch between multiple processing modes in which the consumer-operated tuner system 120 decodes none, part, or all received data locally at the consumer-operated tuner system 120 or the consumer-operated tuner system 120 forwards all, part, or none of a set of received encoded data to system 125 for processing in downstream video processor 275.

Thus, video processor 275 can be a supplemental video processor and/or data processing function disposed in hardware/software at an external location with respect to the consumer-operated tuner system 125.

During operation, and subsequent to being configured, the consumer-operated tuner system 120 receives, for example, compressed video data or encoded information on one or more data channels received from a server 104. The user 108 can provide input to notify content selector 210 of particular content to transmit to consumer-operated tuner system 120 for eventual decoding and playback on playback device 130.

In one embodiment, based on the input, the content selector 210 of consumer-operated tuner system 120 notifies server 104 of selected content. Accordingly, a user 108 can select amongst one or more television channels, movies, documentaries, music, videos, etc., to be played back on playback device 130 such as a display screen and/or audio system.

As is known in the art, the content received from the server 104 can be compressed or encoded in order to make use of limited bandwidth between the server 104 and the consumer-operated tuner system 120. As is known, compression reduces an amount of bandwidth required to transmit a signal over network 190.

In addition to being compressed, note that the content received by system 125 from the consumer-operated tuner system 120 also may be encrypted. System 125 can be programmed with one or more decryption keys to decrypt received content. In one embodiment, system 125 obtains a decryption key from the server 104 or other source during an authorization phase.

The consumer-operated tuner system 120 can switch between operating in the different modes based on received control information. For example, any source such as server 104, consumer-operated tuner system 120, user 108, etc., can originate the control information for setting consumer-operated tuner system 120 and/or system 125 into a respective operational mode.

To operate in a respective mode, a control source sends suitable command control signals to either or both the consumer-operated tuner system 120 and the system 125 to configure mode selector 220 and mode selector 270 for operation. For example, system 125 can receive a notification (e.g., message, command, etc.) from the consumer-operated tuner system 120 and/or other source such as user 108, server 104, etc. indicating to set system 125 to a first mode in which system 125 and corresponding video processor 275 operates to decode the received content and generate a playback signal for transmitting to playback device 130. While in the first mode, a video data stream of content received by system 125 from the consumer-operated tuner system 120 is not yet decoded for playback by playback device 130.

Thus, in response to receiving the mode command from the consumer-operated tuner system 120 or other source, system 125 operates the video processor 275 to receive the video data stream from the consumer-operated tuner system 120, generate the playback signal, and transmit the playback signal to the playback device 130.

Thus, when in a first mode, in lieu of providing any or all decoding or other processing services of the selected video data at the consumer-operated tuner system 120, the consumer-operated tuner system 120 controls multiplexer 215 to transmit the compressed video data from the consumer-operated tuner system 120 on, for example, bypass path 230 to a downstream video processor 275 disposed in communication link 122.

The video processor 275 executes any of one or more enhanced processing services to the video data received from the consumer-operated tuner system 120. For example, in one embodiment, the video processor 275 can apply enhanced decoding to compressed video data received from the consumer-operated tuner system 120. Also, the video processor 275 can pass received video to the playback device 130 without further processing.

Enhanced processing services provided by the video processor 275 are not limited to decoding. As described herein, the video processor 275 can provide any of one or more enhanced video processing services with respect to services provides by the consumer-operated tuner system 120. For example, the enhanced video processing services in the video processing 275 can provide enhanced picture quality, higher resolution, higher refresh frame rates, enhanced signal to noise ratio, enhanced color quality, 3-D video, supplemental graphics, etc.

Additionally, when in the first operational mode of providing enhanced processing services, note that the mode selector 270 in system 125 controls multiplexer 265 such that the encoded data received from consumer-operated tuner system 120 is transmitted to video processor 275 for processing. Note that multiplexer 265, mode selector 270 and video processor 275 logically represent circuitry in system 125. However, note that any suitable circuitry can be used to provide the same functionality of providing enhanced video processing services.

As mentioned, processing by the video processor 275 can include decoding. For example, in one embodiment, video processor 275 decodes the received data (e.g., encoded data, compressed data, etc.) as discussed above and then outputs a generated, decoded signal to playback device 130 for playback.

As previously discussed, when in the first mode, the downstream video processor 275 residing in communication link 122 provides enhanced video processing services such as enhanced decoding with respect to video decoding services provided by the consumer-operated tuner device 120. In one example embodiment, the consumer-operated tuner system 120 includes less sophisticated hardware and/or firmware and is thus not able to provide the enhanced processing functionality as is provided by system 125. Accordingly, disposing enhanced functionality in communication link 122 as described herein affords a unique way of providing enhanced video processing capabilities to a user without having to physically replace the consumer-operated tuner system 120 with new hardware.

As previously discussed, a source controlling operational modes of the consumer-operated tuner system 120 and the system 125 can switch between operating the consumer-operated tuner system 120 in a first mode in which the consumer-operated tuner system 120 transmits the video data for processing by the downstream video processor 275 and a second mode in which the consumer-operated tuner system 120 processes the video data locally into a playback signal that is passed through the downstream video processor 275 to the remote playback device 130 for playback.

Consumer-operated tuner system 120 and/or system 125 can receive control information from the control source (e.g., server, user, and/or other source) to operate in a second operational mode.

While in the second mode, multiplexer 215 of consumer-operated tuner system 120 is configured to forward selected content such as video data to video decoder 225 for decoding in consumer-operated tuner system 120 rather than forward the content to video processor 275 in system 125 for applying enhanced processing services.

Thus, in the second mode, the multiplexer 215 passes received content to video decoder 225 for local processing and decoding in the consumer-operated tuner system 120.

In this second mode, the video decoder 225 decodes the content in accordance with a selected protocol and transmits the decoded data (e.g., a playback signal encoded according to HDMI protocol) to system 125. For example, system 125 includes mode selector 270. When video decoder 225 provides decoding services in the second mode, the mode selector 270 controls multiplexer 265 in system 125 such that the received, decoded signal received from consumer-operated tuner system 120 is sent on bypass path 280 (bypassing video processor 275) to the playback device 130 for playback. Thus, system 125 can operate in a pass-thru mode without further decoding and/or apply any of one or more enhanced processing services to the video data received from the consumer-operated tuner system 120.

Note that certain embodiments herein can include operating in a third mode or yet other modes in which none or both the video decoder 225 and the video processor 275 are used to decode content that is to be played back on playback device 130. For example, video decoder 225 can decode a first portion of received content while video processor 275 can provide decoding or some further processing of the received decoded signal to produce an enhanced playback signal for playback on playback device 130. This will be discussed later in this specification.

System 125 can receive a notification (e.g., message, command, etc.) from the consumer-operated tuner system and/or other source such as user 108, server 104, etc. indicating to set the system 125 to the second mode.

In one embodiment, a received command notifies the system 125 and thus video processor 275 to operate in the second mode in which content such as a video data stream received from the consumer-operated tuner 120 is not processed locally in the consumer-operated tuner system 120 for playback by the playback device 130. In response to receiving the command from the consumer-operated tuner system 120 to operate in the second mode, the mode selector 270 of system 125 operates the video processor 275 in the communication link 122 to receive the video data stream from the consumer-operated tuner system 120, decode and/or apply some other enhanced video processing to the received video data to produce a playback signal, and transmit the playback signal to the playback device 130 for playback.

In other example embodiments, system 125 can be configured to combine a playback signal such as decoded data received from the consumer-operated tuner system 120 with content decoded or processed by system 125 to produce a playback signal transmitted to playback device 130. Thus, in this latter example embodiment, each of the consumer-operated tuner system 120 and the system 125 can provide some amount of processing to received video data that, when combined, results in generation of a playback signal for playback on playback device 130.

As previously discussed, replacement of a conventional cable between consumer-operated tuner system 120 and the system 125 with the communication link 122 provides a useful way of upgrading current electronics and corresponding functionality. That is, the downstream video processor 275 in the communication link 122 can be configured to receive and process the encoded video data to provide enhanced video decoding and/or processing services (e.g., higher resolution playback, higher refresh frame rates, enhanced signal to noise ratio, enhanced color quality, 3-D graphics, etc.) with respect to video decoding and/or processing services supported by a video decoder in a conventional set-top box.

More specifically, in one embodiment, the video processor 275 executes enhanced video processing services to produce a processed video data stream having a higher refresh frame rate than a refresh frame rate supported by video processing services in the consumer-operated tuner system 120.

In accordance with another embodiment, the video processor 275 executes video processing services to produce a processed video data stream having a higher signal to noise ratio than a signal to noise ratio supported by video processing services in the consumer-operated tuner system 120.

In accordance with yet another embodiment, the video processor 275 provides enhanced color quality processing services with respect any color quality processing services provided by the consumer-operated tuner system 120.

In accordance with yet another embodiment, the video processor 275 can provide 3-dimensional processing services that are not supported by the consumer-operated tuner system 120.

In accordance with yet another embodiment, note that content or data received from server 104 can include a multi-layered encoded signal such as SVC. For example, the server 104 can forward a base video data stream and an enhancement layer associated with the base video data stream to consumer-operated tuner system 120. The video decoder 225 in the consumer-operated tuner system 120 may be able to support only decoding of the base video data stream but not the enhancement layer. In contrast, the video processor 275 in system 125 can be configured to decode a combination of the base video data steam and the enhancement layer to provide, for example, a higher resolution playback signal to be forwarded to playback device 130. The enhancement layer video data stream enables the video processor 275 to create the higher resolution playback signal.

Accordingly, during operation, the consumer-operated tuner system 120 can either decode the received base video data or transmit the base data video stream to the video processor 275 for decoding.

Further, the video processor 275 can decode the base video data stream (e.g., compressed content supporting a 720p resolution) and/or a combination of the base video data stream and the enhancement layer data stream (e.g., compressed data supporting an upgrade from 720p to 1080p resolution) as mentioned above.

As mentioned, the video decoder 225 in the consumer-operated tuner system 120 may be capable of decoding the base video data stream but not the enhancement layer video data stream. Accordingly, installment of the communication link 122 (e.g., system 125) provides enhanced functionality over conventional methods.

Presence of communication link 122 and/or the system 125 can be learned in a number of ways. For example, the consumer-operated tuner system 120 can be configured to generate a query message transmitted from communication interface 235 to communication interface 260 of system 125. Thus, system 125 can receive the query message from the consumer-operated tuner system 120.

In response to receiving the query message, system 125 communicates over a portion of the communication link 122 between the video processor 275 and the consumer-operated tuner system 120 to notify the consumer-operated tuner system 120 of a presence of the video processor 275 and/or any portion of system 125 disposed between the consumer-operated tuner system 120 and the playback device 130.

Subsequent to discovering a presence of system 125 and/or components therein, other systems such as server 104 can be notified by consumer-operated tuner system 120 of the presence of the system 125 and its enhanced processing capabilities.

In accordance with further communications herein, system 125 can be configured to receive one or more configuration notifications from the consumer-operated tuner system 120 or other source.

In addition to indicating mode settings as discussed above, a configuration notification can be a command indicating a format type of the decoded video data stream to be transmitted from the video processor 275 to the playback device 130. In response to receiving this type of configuration notification, the mode selector 270 or other suitable functional module in system 125 programs the video processor 275 to decode a received video data stream into the format type as specified by the configuration notification. Accordingly, the consumer-operated tuner system 120, server 104, user 108 and/or other source is able to configure system 125 to perform different operations.

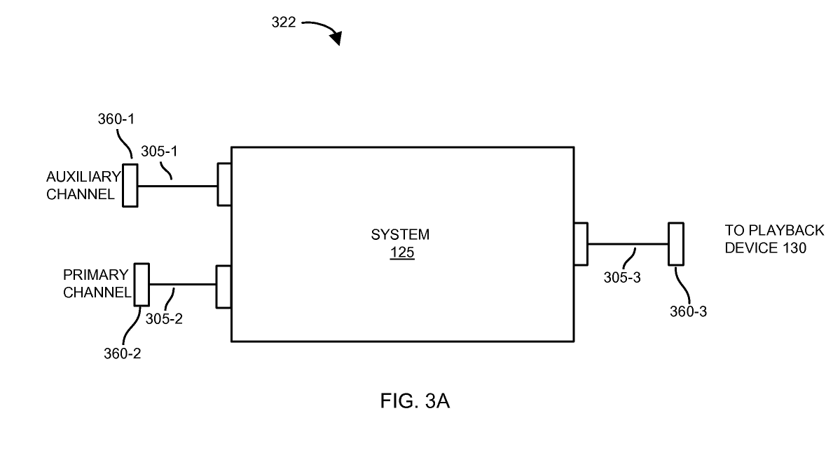

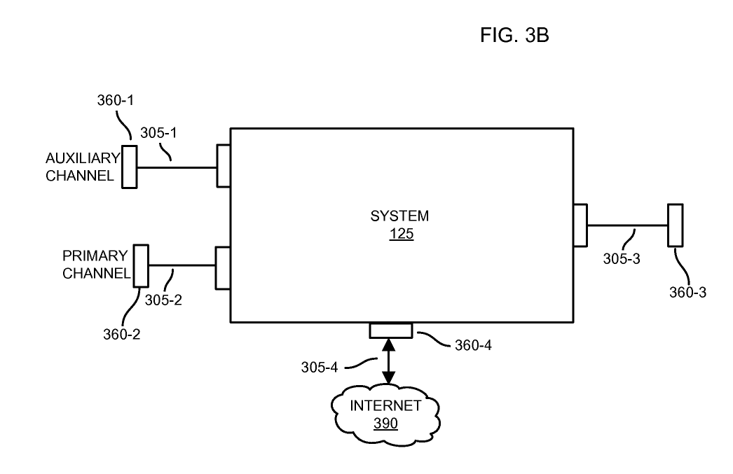

FIG. 3A is an example diagram illustrating a communication link 322 according to embodiments herein. As shown in this embodiment, communication link 322 includes link 305-1, link 305-2, and link 305-3. Connectors disposed at ends of the links 305 can be connected to different devices. For example, connector 360-1 can be connected to consumer-operated tuner system 120 to provide connectivity between consumer-operated tuner system 120 and system 125. Connector 360-3 can be connected to playback device to provide connectivity between system 125 and playback device 130. Connector 360-2 can be connected to consumer-operated tuner system 120 or other device.

System 125 can include any number of connections on which to receive and transmit data to external resources.

By way of non-limiting example, link 305-2 (a primary channel) can be a physical cable (e.g., flexible bundle of wires) on which to receive encoded data or decoded video from the consumer-operated tuner system 120 as previously discussed. In one embodiment, link 305-2 is an HDMI type cable providing connectivity between consumer-operated tuner system 120 and system 125 via, for example, the HDMI protocol.

As discussed above, in lieu of generating the playback signal locally in consumer-operated tuner system 120, the system 120 can forward the compressed content over the HDMI cable to system 125. A typical HDMI protocol that is normally used to transmit a decoded playback signal over the HDMI cable can be modified to send encoded data to system 125. For example, the physical wires in the HDMI cable can be driven with the compressed video according to any suitable transmission protocol that affords transmission of content over the physical wires of the HDMI configured cable. System 125 can be configured to receive the compressed video data on the physical wires based on the transmission protocol used by the consumer-operated tuner system 120 to send the compressed data.

Also by way of non-limiting example, link 305-3 can be a physical cable on which to connect system 125 to the playback device 130. In one embodiment, link 305-3 is an HDMI type cable providing wired connectivity between consumer-operated tuner system 120 and system 125 based on the HDMI protocol. The playback device 130 can be configured to receive the playback signal according to an HDMI protocol transmitted on the HDMI type cable.

Link 305-1 (e.g., an auxiliary channel) can be a physical cable or wireless medium supporting communications between a port of a source such as the consumer-operated tuner system 120 and a port 310-1 of system 125. In certain embodiments, link 305-1 supports receipt of any or all control information, compressed video data, audio data, etc., from a source such as consumer-operated tuner system 120. Link 305-1 can be a USB type cable connecting the system 125 to consumer-operated tuner system 120.

Note that link 305-1 may be optional and that a main embodiment of communication link 322 in FIG. 3A may only include link 305-2, system 125, and link 305-3.

As previously discussed, communication link 322 can replace an existing HDMI connection or cable between the consumer-operated tuner system 120 and the playback device 130. When present, link 305-1 provides an auxiliary channel on which to communicate with and receive data.

System 125 can be configured to receive power from any number of sources. For example, system 125 can include an input for receiving power from a standard 115 Volt AC receptacle. A power converter disposed in system 125 can convert the received AC voltage into a voltage suitable to power circuitry in system 125.

In another embodiment, system 125 can be configured to receive power from a source such as consumer-operated tuner system 120 through a USB type cable as discussed above.

In accordance with yet another embodiment, if the implementation of system 125 includes a digital interface such as a USB interface for the auxiliary channel in addition to an HDMI interface for the primary channel, consumer-operated tuner system 120 can be configured to transmit graphics and base layer over HDMI and enhancement layer data via USB or it might transmit graphics via HDMI and the base and enhancement layers via USB.

FIG. 3B is an example diagram illustrating an enhanced video processing system according to embodiments herein. As shown, system 125 also can include, via connector 360-4, a connection to the Internet. Based on such embodiments, system 125 can receive data and/or control commands from sources over the Internet in addition to receiving video data from a consumer-operated tuner system 120 as described herein.

According to one embodiment, video processor 275 in system 125 can receive a video data stream from the Internet connection in addition to receiving a video data stream from the consumer-operated tuner system 120. In such an embodiment, the video processor 275 processes the video data stream received from the Internet connection to produce images for display on the playback device 130.

In yet further embodiments, a user operating the playback device 130 can generate commands and/or data that is transmitted from the playback device 130 to system 125. System 125 can forward the commands and/or data to other devices such as consumer-operated tuner system 120 and/or servers located in Internet 390.

### More Sample Applications of System 125

Conventional set-top boxes (e.g., satellite interface box, cable set-top box, etc.) traditionally support video output at a given maximum resolution such as 720p. They are typically connected to high definition televisions using an HDMI interface.

Currently, so-called H.264 Scalable Video Coding (a.k.a., SVC) is a new efficient method of video coding which allows transmission of an H.264 compatible base layer at a given resolution (e.g. 720p) along with an enhancement layer which, when processed in combination with the base layer, provides outputting of a higher resolution (e.g. 1080p) signal. While the following example more particularly illustrates how data distribution environment 100 can operate based on SVC, system 125 can be implemented using any type of video coding.

There are many ways in which an SVC stream might be transmitted from a content service provider such as server 104 (e.g. satellite head-end, cable set-top box, etc.) via a transmission channel (e.g. up to the satellite and down to the satellite dish and set-top box at the viewer's home) to system 125. One example of this is where a service provider (e.g., server 104) transmits an SVC encoded 1080p stream in two layers as mentioned above.

The first layer is an H.264/AVC 720p stream that forms the base layer and is able to be decoded by existing conventional set-top boxes in the field that support H.264/AVC encoded 720p streams. The second layer is the 1080p enhancement layer that can be decoded in concert with the base layer to create 1080p video using enhanced decoding provided by system 125.

In order to allow existing conventional set-top boxes in the field to decode the base layer without any firmware changes, the service provider or sever 104 transmits the 720p base layer in the same way it conventionally transmits any 720p stream. The 1080p enhancement layer is transmitted separately to the consumer-operated tuner system 120.

Conventional set-top boxes that are upgraded with communication link 122 can receive a firmware update that would allow them to receive the enhancement layer and send it along with the 720p base layer for processing by system 125 between the consumer-operated tuner system 120 and the playback device 130.

Traditional methods of building decoder hardware to support new compression standards typically lead to solutions that require replacement of existing hardware (e.g., a conventional set-top box) in order to support the new standard. As mentioned above, system 125, as described in this example application, allows existing devices and electronic circuits such as conventional set-top boxes that support a given maximum resolution (e.g., 720p) to be upgraded to support a higher resolution (e.g., 1080p) using SVC (Scalable Video Coding or H.264/MPEG-4 AVC video) without having to be replaced or redesigned.

Depending on the embodiment, circuitry in system 125 as described herein can be implemented as a single semiconductor chip or as a subsystem made up of a number of interconnected semiconductor chips and related circuitry.

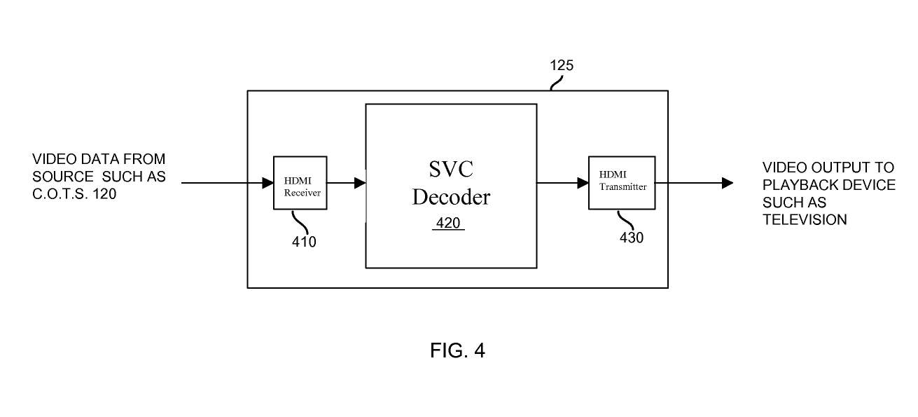

FIG. 4 is a diagram illustrating an example implementation of system 125 according to embodiments herein. As shown, system 125 can be configured to include SVC decoder circuitry 420 (e.g., a specific implementation of processor 275).

For example, according to one embodiment, a consumer electronics device (e.g., a consumer-operated tuner system 120) transmits compressed data in accordance with a compression standard such as the SVC standards over an HDMI cable to an HDMI receiver 410 in system 125. The HDMI receiver 410 passes the received data to SVC decoder circuitry 420. In a manner as discussed above, SVC decoder circuitry 420 (e.g., a specific implementation of processor 275) processes the received data and then transmits (via HDMI transmitter 430) sends a respective decoded signal over an HDMI cable to playback device 130 such as a television.

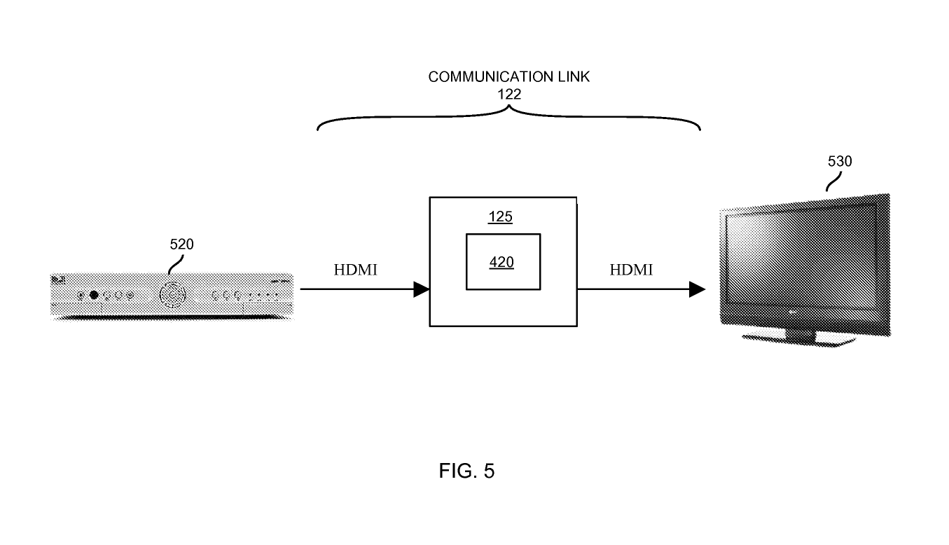

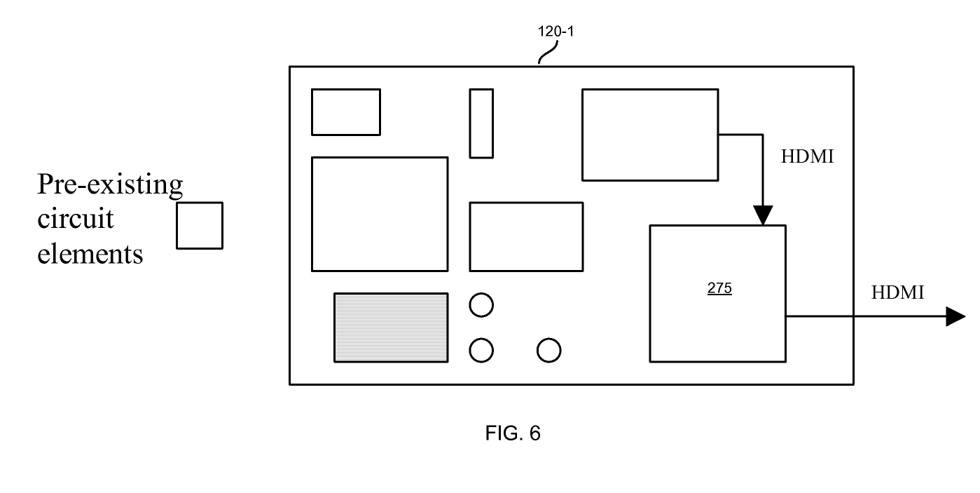

FIGS. 5 and 6 illustrate examples of how decoder 275 can be integrated in different consumer electronic applications according to embodiments herein.

More specifically, FIG. 5 is an example diagram illustrating implementation of decoder 275 as an SVC decoder 420 according to embodiments herein.

During operation, the consumer-operated tuner system 520 may need to perform decoding and output a respective playback signal based on compressed data that is received in a non-SVC type of format. In this circumstance, consumer-operated tuner system 520 decodes the received video data. System 125 contains the SVC decoder 420, which simply acts as a pass-through device passing the signal generated by the consumer-operated tuner system 520 over, for example, an HDMI cable to a playback device 530.

During times when the consumer-operated tuner system 520 receives an SVC encoded data stream, the consumer-operated tuner system 520 transmits the SVC data stream to system 125 over, for example, an HDMI cable according to an HDMI data protocol. The SVC decoder 420 decodes the data stream and transmits the decoded data stream (e.g., playback signal) over an HDMI link to the playback device 530 such as a television.

In yet further embodiments, a source such as the consumer-operated tuner system 520, system 125, etc., can generate or originate graphics to be displayed on playback device 530 along with graphics derived from decoding of video data selected for playback by the consumer-operated tuner system 520. In such an embodiment, either the consumer-operated tuner system 520 and/or system 125 can decode and derive a first set of graphics based on a first set of video received from a source such as server 104.

If the consumer-operated tuner system 520 decodes the video data, the consumer-operated tuner system 520 forwards the decoded video data to system 125. System 125 can receive and decode a second set of encoded video data to derive a second set of graphics. System 125 then produces a playback signal based on a combination of the first set of graphics and second set of graphics. System 125 transmits the playback signal to playback device 530 for playback.

Embodiments herein enable overlaying graphics on content being played back on playback device 530. For example, a user can select particular content for playback as previously discussed. During playback of the selected content on playback device 530, the consumer-operated tuner system 120 and/or system 125 may generate additional graphics to be overlaid on the content currently being played back on playback device 530. The new graphics can be generated by any source such as server 104, consumer-operated tuner system 520, system 125, etc. In one embodiment, the user may perform an operation that requires overlaying a new set of graphics over the content being played back on the playback device 530. As discussed below later in this specification, graphics can be overlaid in a number of ways.

Note that embodiments herein include operating the processor 275 or SVC decoder 420 of system 125 to receive auxiliary (encoded or compressed) video data from a source such as the consumer-operated tuner system 520 in addition to receiving a compressed video data of content being played back on the playback device 530. The auxiliary data represents content such as video graphics originated by the consumer-operated tuner system 520 or other source for overlaying on video graphics of the content currently played back on the playback device 530.

As mentioned, to produce the playback signal of the original content either the consumer-operated tuner system 520 or system 125 can provide decoding to create the playback signal of the original content. In either case, whether system decodes the original content being played back or receives an already decoded data stream, system 125 forwards the playback signal (whether received or decoded locally) to playback device 530 for playback.

System 125 can also receive the auxiliary encoded video data representing graphics to be overlaid on graphics being played back on the playback device 530. In one embodiment, system 125 receives the auxiliary video data (e.g., encoded graphics) as encoded data to be decoded and overlaid on the content currently being displayed. To overlay the newly received graphics, system 125 decodes the auxiliary video data and combines the decoded auxiliary video data (of the original content being played back) with the content currently being displayed to provide new graphics over the current content being played back.

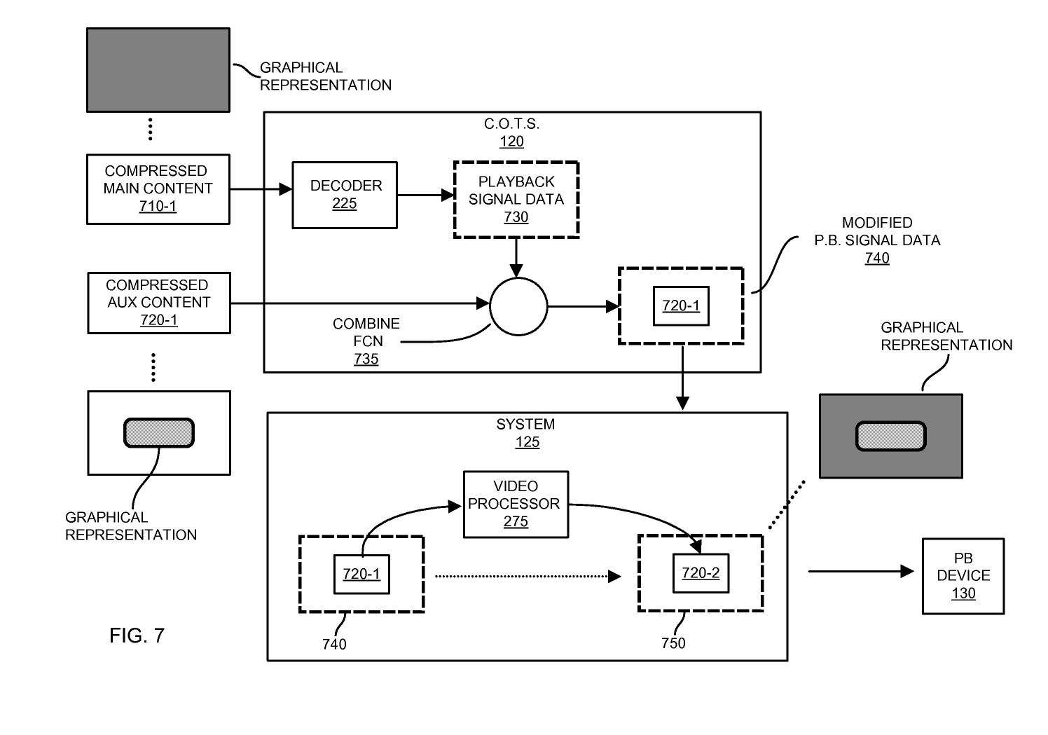

In one embodiment, system 125 receives the original content being played back as an already decoded video signal that has been decoded and transmitted on an HDMI interface from the consumer-operated tuner system 120 to system 125. The consumer-operated tuner system 120 can perform processing to identify regions on a display screen where the auxiliary data is to be overlaid on the original content being played back. Instead of transmitting a complete decoding of the original content to system 125 and transmitting the auxiliary video data as a separate signal, the consumer-operated tuner system 120 can insert the compressed auxiliary data in data fields of the HDMI signal that were otherwise used to transmit the pixel information being overlaid with the graphics of the auxiliary content. This is discussed in more detail in FIG. 7. Thus, the consumer-operated tuner system 120 can transmit a portion of already decoded information to system as well as yet-to-be decoded auxiliary data that represents the graphics for overlaying on graphics derived from the original content. To overlay the graphics on the original content being played back, system 125 decodes the auxiliary content received in the HDMI signal and inserts the newly decoded data associated with the auxiliary data into the playback signal such that graphics associated with the newly decoded data at the system 125 are overlaid on graphics derived from the original content when played back on playback device 130.

FIG. 6 is an example diagram illustrating a consumer-operated tuner system 120-1 according to embodiments herein. This embodiment illustrates that the consumer-operated tuner system 120 can be modified to include video processor 275 or SVC decoder 420, rather than implement the so-called downstream video decoder in communication link 122 as discussed above. In such an embodiment, the HDMI signal normally generated by conventional set-top boxes is forwarded to the video processor 275 in the consumer-operated tuner system 120-1. The consumer-operated tuner system 120-1 operates as follows:

1. In the case where the consumer-operated tuner system 120-1 needs to display video which it has received in formats other than SVC, the consumer-operated tuner system 120-1 decodes the video locally. In this circumstance, the system 125 simply acts as a pass through device passing the playback signal derived by the consumer-operated tuner system 120-1 over an HDMI cable to the television set.

2. In the case where the consumer-operated tuner system 120-1 receives video data in the SVC format, the consumer-operated tuner system 120-1 passes the SVC stream to the video processor 275 in the consumer-operated tuner system 120 in HDMI format. The video processor 275 decodes the SVC stream to produce a playback signal transmitted (via HDMI) to the playback device 130.

3. When graphics are to be displayed along with the video, the graphics may be generated in the consumer-operated tuner system 120-1. Such graphics can be combined with graphics produced by decoding of video data by the video processor 275 in system 125 as mentioned above.

Referring again to the above figures, there are many ways in which a consumer-operated tuner system 120 can transmit information to system 125 according to further embodiments herein.

For example, in accordance with one embodiment as in FIG. 7, the consumer-operated tuner system 120 can transmit a set of compressed auxiliary data to system 125 by embedding the compressed auxiliary data (e.g., compressed data such as in SVC format) in unused portions of vertical or horizontal blanking sections (e.g., sections that will overlaid with new graphics derived from the auxiliary data) of a video signal.

More specifically, as shown in FIG. 7, the consumer-operated tuner system 120 can receive and decode (via decoder 225 in system 125) compressed main content 710-1 to produce an uncompressed playback signal 730. Playback signal 730 can be generated in an uncompressed format that is capable of being played back on playback device 130. By way of non-limiting example, the uncompressed playback signal 730 can be generated according to an HDMI protocol and define coloration and intensity for a complete image to be displayed on a display screen.

In addition to receiving the compressed main content 710-1, the consumer-operated tuner system 120 can receive and/or originate compressed auxiliary content 720-1. As previously discussed, the consumer-operated tuner system 120 can initiate display of images or graphics (derived from the compressed auxiliary content 720-1) over portions of video defined by compressed main content 710-1. For example, compressed main content 710-1 can represent video received on a selected television channel for initial playback and viewing by a user. The compressed auxiliary content 720-1 can be originated by the consumer-operated tuner system 120 in response to input such as a user pressing a guide button on a remote control device. Pressing the guide button can prompt the consumer-operated tuner system 120 to overlay suitable set of video graphics on a television channel (e.g., compressed main content 710-1) currently being decoded and displayed for viewing by the user. The compressed auxiliary content 720-1 can represent the guide information or other graphical overlay information overlay that is to be overlaid on the television channel.

Thus, a portion of pixels, graphics, images, etc., defined by the (uncompressed) playback signal 730 can be overlaid with pixels, graphics, images, etc., as defined by compressed auxiliary content 720-1. Instead of decoding the compressed auxiliary content 720-1 locally in the consumer-operated tuner system 120 and combining the decoded auxiliary content into playback signal data 730 as is done in conventional applications, the combine function 735 according to embodiments herein identifies one or more portions of the original playback signal 730 defining regions on a display screen that that will be overlaid with the images defined by the compressed auxiliary content 720-1. In place of at least some of the respective data fields (e.g., active region) of playback signal data 730 defining portions of a display screen that will be overlaid with images of the compressed auxiliary content 720-1, the consumer-operated tuner system 120 writes (all or some of) these respective data fields with the compressed auxiliary content 720-1 as shown. In other words, combine function 735 inserts compressed auxiliary data 720-1 into appropriate data fields of active regions of playback signal 730 to create modified playback signal 740. Modified playback signal 740 thus includes compressed and uncompressed content.

The consumer-operated tuner system 120 then transmits the modified playback signal 740 (including compressed and uncompressed content) to system 125 for further processing. The consumer-operated tuner system 120 or other source can provide (in the modified playback signal 740 or other out of band signal) notification to system 125 as to which of one or more data fields of the modified playback signal includes the compressed auxiliary content 720-1. In one embodiment, the notification includes a pointer or other suitable information that indicates one or more regions in the original playback signal 730 that includes or may include the compressed auxiliary content 720-1. System can search the fields to find the compressed data.

Subsequent to receipt, and based on the notification, system 125 locates, retrieves, and decodes the compressed auxiliary data 720-1 in the received modified playback signal 740. Recall that playback signal 740 includes a portion of already decoded data such as a portion of playback signal 730. Such data does not need to be decoded by system 125 as it is already in playback form based on processing provided by consumer-operated tuner system 120.

Based on decoding of the compressed auxiliary data 720-1 into uncompressed auxiliary content 720-2 as shown in FIG. 7, system 125 produces playback signal 750. For example, in one embodiment, to produce playback signal 750, system 125 populates the respective data fields (where the compressed auxiliary data 720-1 was stored in playback signal 740 and other appropriate data fields in the modified playback signal 740 where data is to be overlaid with new graphics) such that the playback signal 750 created by system 125 defines graphics associated with the auxiliary content 720-1 being overlaid on graphics associated with the main content 710-1 as is shown on FIG. 7.

Thus, in accordance with such an embodiment, graphics can be generated in the consumer-operated tuner system 120 or other source and passed as compressed content to system 125 in the active parts of a video playback signal sent to system 125. The decoder circuitry in system 125 can be configured to decompress, for example, SVC data inserted into a playback signal and combine it with the graphic information of the received playback signal (which may or may not need to be scaled) to produce a respective playback signal for playback on playback device 130.

As an alternative to transmitting compressed content in the active regions of a playback signal, encoded or compressed data can be transmitted from the consumer-operated tuner system 120 in inactive portion of a playback signal that is transmitted to the system 125. In such an embodiment, an active portion of an HDMI data or playback signal transmitted to system 125 can include uncompressed data defining color, intensity, etc., of graphics to be displayed on a display screen. The encoded, compressed portion of content to be overlaid on the main graphics in the active portion can be transmitted to system 125 in an inactive portion of the playback signal received from the consumer-operated tuner system 120. Thus, the compressed data in the inactive region defines graphics to be overlaid on graphics as represented by information stored in the active region of received playback signal.

In such an embodiment, system 125 decodes the compressed data received in the inactive region and combines or overlays graphical information derived from the compressed data (in the inactive region) with the received uncompressed data (in the active region) to produce a playback signal in which the graphics associated with the compressed data received by system 125 is overlaid on graphics associated with the uncompressed data received by system 125.

In accordance with further embodiments herein, the consumer-operated tuner system 120 can send SVC or other types of encoded data to system 125 in the active part of the video signal in areas where there are no graphics in the original playback signal. In such an embodiment, compressed content can be stored in the inactive region of the playback signal. In such an instance, the encoded data integrated into the original playback signal does not displace playback data in the active region of the original playback signal.

In accordance with yet another embodiment, the consumer-operated tuner system 120 can send graphics in some type of compressed, encoded format along with encoded compressed SVC data in an active portion of a generated HDMI video signal. In such an embodiment, the processor in system 120 would decode both the graphics and the compressed SVC data (received in the active region of a playback signal) to produce a playback signal transmitted to playback device 130.

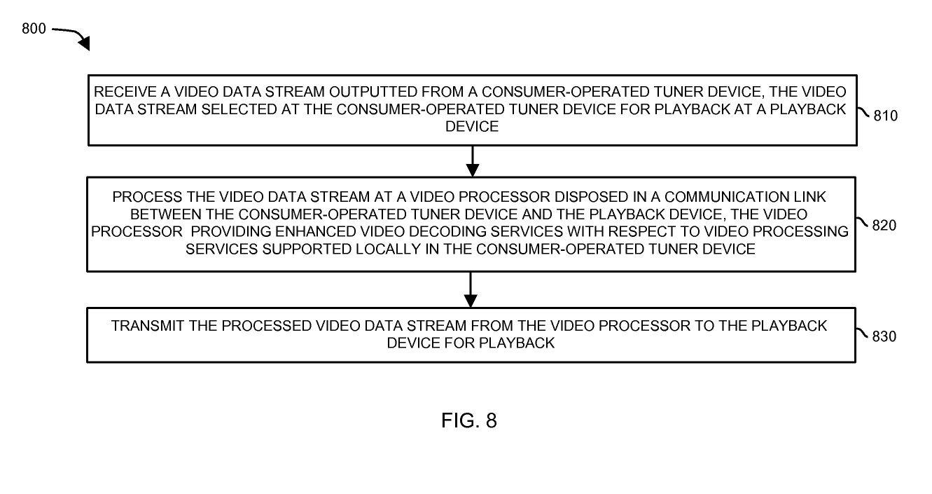

FIG. 8 is a flowchart illustrating an example method supporting enhanced processing services according to embodiments herein.

In step 810, system 125 receives a video data stream outputted from the consumer-operated tuner system 120. The video data stream has been selected at the consumer-operated tuner system 120 for playback at a playback device 130.

In step 820, video processor 275 of system 125 processed the video data stream. As previously discussed, the video processor can be disposed in communication link 122 between the consumer-operated tuner system 120 and the playback device 130. Also, the video processor 275 provides enhanced video processing services with respect to services supported locally in the consumer-operated tuner system 120.

In step 830, system 125 transmits the processed video data stream to the playback device 130 for playback.

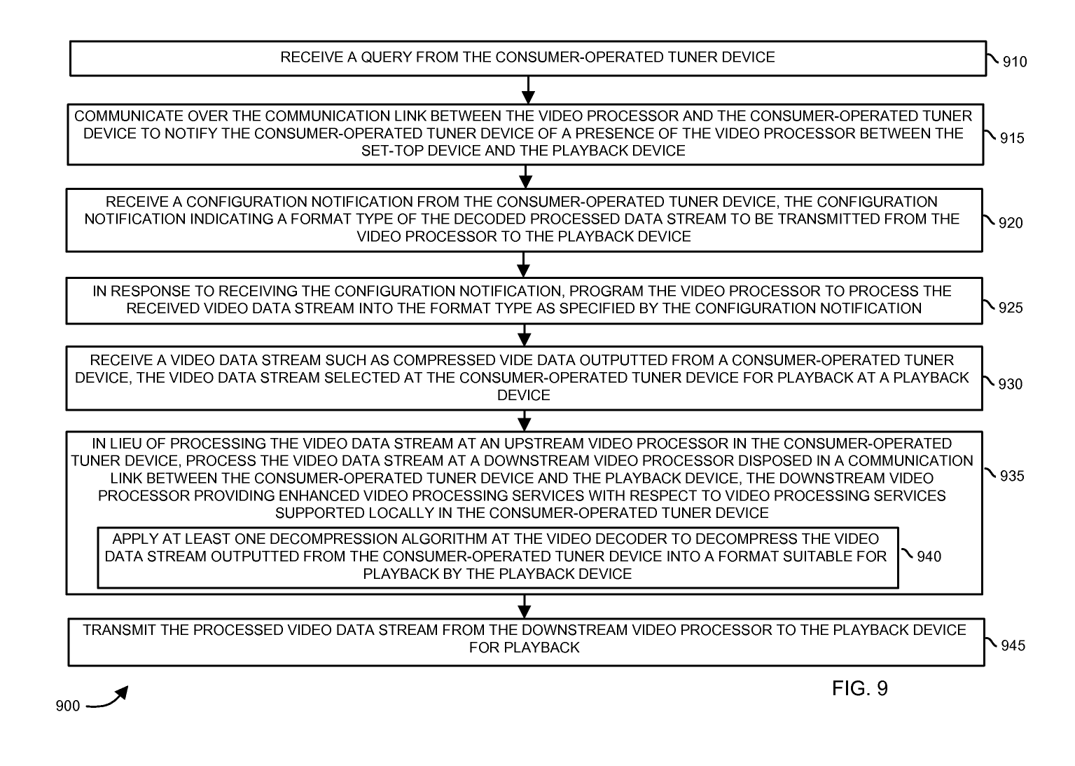

FIG. 9 is a flowchart illustrating an example method supporting enhanced processing services in a downstream video processor according to embodiments herein.

In step 910, system 125 receives a query from the consumer-operated tuner system 120. In one embodiment, the consumer-operated tuner system 120 sends the query to system 125 to determine whether the communication link 122 and system 125 is present between the consumer-operated tuner system 120 and the playback device 130.

In step 915, system 125 communicates over a portion of the communication link 122 between the video processor 275 and the consumer-operated tuner system 120 to notify the consumer-operated tuner system 120 of a presence of the video processor 275 between the consumer-operated tuner system 120 and the playback device 130.

In step 920, system 125 receives a configuration notification from the consumer-operated tuner device 120. The configuration notification indicates a format type of the processed video data stream to be transmitted from the video processor 275 to the playback device 130.

In step 925, in response to receiving the configuration notification, system 125 configures or programs the video processor 275 to processe the received video data stream from the consumer-operated tuner system 120 into one or more format types as specified by the configuration notification.

In step 930, system 125 receives a video data stream such as compressed video data outputted from a consumer-operated tuner system 120. As previously discussed, the video data stream received by system 125 has been selected by a user at the consumer-operated tuner device for playback at a playback device 130.

In step 935, in lieu of processing the video data stream at an upstream video processor (e.g., video decoder 225 in the consumer-operated tuner device), system 125 processes the video data stream via video processor 275 disposed in communication link 122 between the consumer-operated tuner system 120 and the playback device 130. The downstream video processor (e.g., video processor 275) provides enhanced video processing services with respect to video processing services supported locally in video decoder 225 of the consumer-operated tuner system 120.

In step 940, system 125 applies at least one decompression algorithm at the video processor 275 to decompress the video data stream outputted and received from the consumer-operated tuner system 120. Based on application of the decompression algorithm and/or other processing, the video processor 275 produces a playback signal in a format suitable for playback by the playback device 130.

In step 945, subsequent to processing, system 125 transmits the processed video data stream from the (downstream) video processor 275 to the playback device 130 for playback.

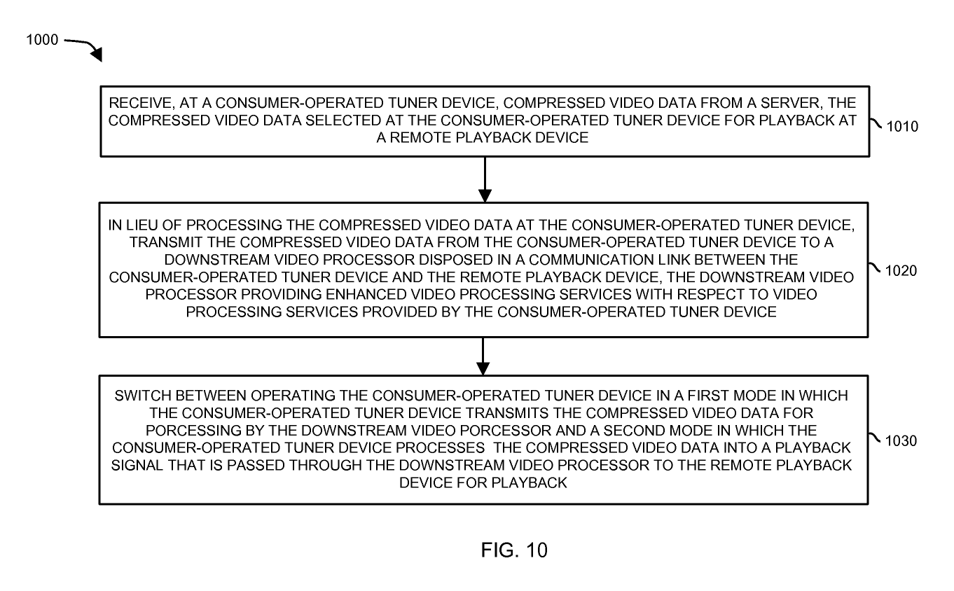

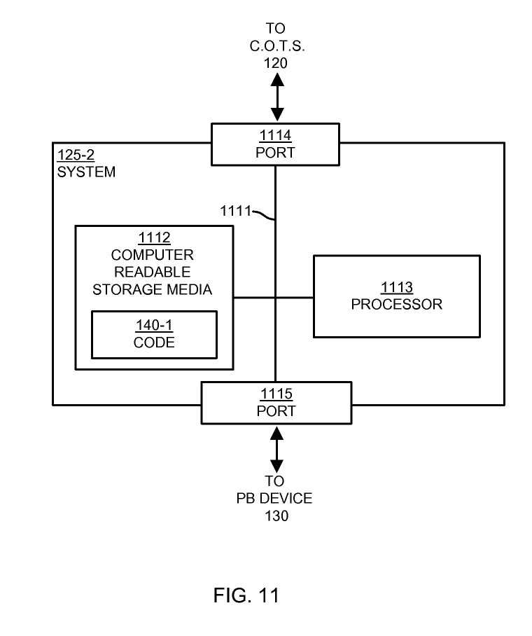

FIG. 10 is a flowchart illustrating an example method of operating a consumer-operated tuner system according to embodiments herein.

In step 1010, the consumer-operated tuner system 120 receives compressed video data from server 104. As previously discussed, in one embodiment, the user 108 selects particular content to be played back at the remote playback device 130.

In step 1020, in lieu of processing the compressed video data via (upstream) video decoder 225 in the consumer-operated tuner system 120, the consumer-operated tuner system 120 transmits the compressed video data to (downstream) video processor 275 disposed in communication link 122 between the consumer-operated tuner system 120 and the remote playback device 130. The (downstream) video processor 275 in communication link 122 provides enhanced video processing services with respect to video processing services provided by the consumer-operated tuner system 120.

In step 1030, the mode selector 220 of consumer-operated tuner system 120 switches between operating the consumer-operated tuner system 120 in a first mode in which the consumer-operated tuner system 120 transmits the compressed video data for processing by the (downstream) video decoder 225 and a second mode in which the consumer-operated tuner system 120 decodes the compressed video data into a playback signal that is merely passed through the (downstream) video processor of communication link 120 to the remote playback device 130 for playback.

FIG. 9 is a block diagram of an example architecture in which system 125-2 includes one or more processors, computer readable storage media, etc., for executing code 140-1 (e.g., software instructions, firmware, etc.) to perform operations as described herein.

Note that the following discussion provides a basic example embodiment indicating how to carry any portions of the functionality associated with the system 125-2 as discussed above and below. However, it should be noted again that the actual configuration for carrying out system 125-2 can vary depending on a respective application. For example, the system 125 can be all hardware, or a hybrid design including a combination out-of-focus hardware and software to provide the functionality as described herein.

As shown in the present example, system 125-2 of the present example includes an interconnect 1111 coupling memory system 1112, a processor 1113, port 1114, and port 1115.

Port 1114 provides connectivity and supports communications with consumer-operated tuner system 120. Port 1115 provides connectivity and supports communications with playback device 130.

As shown in this example embodiment, computer readable storage medium 1112 such as memory, flash, RAM, ROM, floppy, hard drive, optical media, etc. can be encoded with instructions such as code 140-1 to perform the various operations as described herein. The code 140-1 can represent an application accessed and executed by processor 1113.

During operation of one embodiment, processor 1113 accesses computer readable storage medium 1112 via the use of interconnect 1111 in order to launch, run, execute, interpret or otherwise perform the logic instructions or code 140-1. Execution of the code produces different processing functionality provided by processor 1113.

It should be noted that, in addition to the operations as described herein, other embodiments herein include the code 130 itself such as the un-executed code stored on computer readable storage medium 1112.

Note again that techniques herein are well suited for use in content processing applications. However, it should be noted that embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

What is claimed is:

1. A method comprising:
receiving a video data stream output from a consumer-operated tuner system, the video data stream selected at the consumer-operated tuner system for playback at a playback device;
decoding the video data stream at a video processor disposed in a communication link between the consumer-operated tuner system and the playback device, the video processor providing enhanced video processing services with respect to video processing services supported locally in the consumer-operated tuner system; and
transmitting the processed video data stream from the video processor to the playback device for playback.

2. The method as in claim 1, wherein the video processor is a downstream video processor in the communication link with respect to an upstream video processor in the consumer-operated tuner system, the consumer-operated tuner system transmitting the video data stream to the downstream video processor in lieu of processing the video data stream at the upstream video processor in the consumer-operated tuner system.

3. The method as in claim 1, wherein receiving the video data stream output from the consumer-operated tuner system comprises receiving compressed video data output from the consumer-operated tuner system, the consumer-operated tuner system receiving the compressed video data from a server over a network; and
wherein processing the video data stream at the video processor comprises applying at least one decompression algorithm at the video processor to decompress the video data stream output from the consumer-operated tuner system into a format suitable for playback by the playback device.

4. The method as in claim 1, wherein receiving the video data stream output from the consumer-operated tuner system comprises receiving a compressed base layer and one or more compressed enhancement layers associated with the base layer, the consumer-operated tuner system capable of decoding the base layer but not the enhancement layers; and
wherein decoding the received compressed video data stream at the video processor comprises:
decoding both the base layer and one or more of the enhancement layers in the video processor to produce the processed video data stream transmitted to the playback device.

5. The method as in claim 1 further comprising:
from the video processor, communicating over the communication link between the video processor and the consumer-operated tuner system to notify the consumer-operated tuner system of a presence of the video processor between the consumer-operated tuner system and the playback device.

6. The method as in claim 5, wherein communicating over the communication link occurs in response to receiving a query from the consumer-operated tuner system.

7. The method as in claim 1 further comprising:
receiving a configuration notification from the consumer-operated tuner system, the configuration notification indicating a format type of the processed video data stream to be transmitted from the video processor to the playback system; and
in response to receiving the configuration notification, programming the video processor to process the received video data stream into the format type as specified by the configuration notification.

8. The method as in claim 1 further comprising:
receiving a command from the consumer-operated tuner system, the command notifying the video processor that the video data stream received from the consumer-operated tuner system represents uncompressed video produced by the consumer-operated tuner system for playback by the playback device; and
in response to receiving the command from the consumer-operated tuner system, operating the video processor in the communication link to receive the video data stream from the consumer-operated tuner system, perform any other required video processing, and transmit the processed video data stream to the playback device.

9. The method as in claim 1, wherein the consumer-operated tuner system resides in a consumer environment in which a respective consumer operates the consumer-operated tuner system to select the video data stream for playback by the playback device; and
wherein the video processor is a supplemental video processor disposed in a housing at a remote location with respect to to a housing of the consumer-operated tuner system, the video processor disposed in the communication link providing higher quality video processing than a quality of video processing supported by the consumer-operated tuner system.

10. The method as in claim 1 further comprising:
operating the video processor to receive auxiliary data from the consumer-operated tuner system in addition to receiving the video data stream, the auxiliary data representing graphics originated by the consumer-operated tuner system; and
producing the processed video data stream by combining the auxiliary data with the processing of the received video data stream.

11. The method as in claim 1, wherein the enhanced processing services of the video processor includes at least one decoding service that produces a video signal for rendering higher resolution images than can be supported by any of the decoding services supported by the consumer-operated tuner system.

12. A method comprising:
receiving, at a consumer-operated tuner system, compressed video data from a server, the compressed video data selected at the consumer-operated tuner system for playback at a playback device; and
in lieu of decoding the compressed video data at the consumer-operated tuner system, transmitting the compressed video data from the consumer-operated tuner system to a downstream video processor disposed in a communication link between the consumer-operated tuner system and the playback device, the downstream video processor providing enhanced video processing services with respect to video processing services provided by the consumer-operated tuner system.

13. The method as in claim 12 further comprising:
switching between operating the consumer-operated tuner system in a first mode in which the consumer-operated tuner system transmits compressed video data for decoding by the downstream video processor and a second mode in which the consumer-operated tuner system decodes the compressed video data into a decoded video stream that is passed through the downstream video processor to the playback device for playback.

14. The method as in claim 13, wherein decoding of the compressed video data by the downstream video processor in the first mode produces a video signal for rendering higher resolution images than does decoding of the compressed video data by the consumer-operated tuner system in the second mode.

15. The method as in claim 12, wherein transmitting the video data stream includes:
transmitting a compressed base layer from the consumer-operated tuner system to the downstream video processor, the base layer supporting a first playback quality when rendered on the playback device; and
transmitting, from the consumer-operated tuner system to the downstream video processor, one or more compressed enhanced layers associated with the base layer, a combination of the base layer and the enhanced layers supporting one more additional playback qualities on the playback device, with each additional playback quality being better than the first playback quality.

16. A service enhancing device that resides between a consumer-operated tuner system and a playback device, the service enhancing device comprising:
a first input to receive an video data stream from the consumer-operated tuner system, the video data stream passing through the tuner device without being processed by the tuner device;
a video processor configured to receive the video data stream and perform an enhanced video processing operation on the video data stream to produce an enhanced processed video data stream, the enhanced processed video data stream being a processed video data stream that is not capable of being provided by video processing functions in the consumer-operated tuner system; and
an output to transmit the enhanced processed video data stream to the playback device for presentation to a user.

17. A service enhancing device as in claim 16, wherein:
the first input is a connector at a first end of a cable, the connector at the first end of the cable configured to connect to a connector of the consumer-operated tuner system;
the output is a connector at a second end of the cable, the connector at the second end of the cable configured to connect to a connector of the playback device;
the playback device is a display device for displaying images; and
the video processor is disposed in a housing integrated with the cable between the first end and second end, the first end of the cable coupled to the housing via a first portion of the cable, the second end of the cable coupled to the housing via a second portion of the cable.

18. A service enhancing device as in claim 17, wherein:
the enhanced video processing operation performed by the video processor is a Scalable Video Coding (SVC) decoding operation that uses at least one enhancement layer along with a base layer, each of which are present in the video data stream received via the first input.

19. A system comprising:
an input to receive a video data stream output from a consumer-operated tuner system, the video data stream selected at the consumer-operated tuner system for playback at a playback device;
a video processor to process the video data stream, the video processor disposed in a communication link between the consumer-operated tuner system and the playback device, the video processor providing enhanced video processing services with respect to video processing services supported in the consumer-operated tuner system; and
an output to transmit the processed video data stream from the video processor to the playback device for playback.

20. The system as in claim 19, wherein the video processor in the communication link is a downstream video processor with respect to an upstream video processor in the consumer-operated tuner system, the consumer-operated tuner system configured to transmit the video data stream to the downstream video processor in lieu of processing the video data stream at the upstream video processor in the consumer-operated tuner system.

21. The system as in claim 19, wherein the video data stream is compressed video data output from the consumer-operated tuner system, the consumer-operated tuner system receiving the compressed video data from a server over a network; and
wherein the video processor applies at least one decompression algorithm to decompress the video data stream output from the consumer-operated tuner system into a format suitable for playback by the playback device.

22. The system as in claim 19, wherein the video data includes a compressed base layer and one or more compressed enhancement layers associated with the base layer, the consumer-operated tuner system capable of decoding the base layer but not the enhancement layers; and
wherein the video processor decodes both the base layer and one or more of the enhancement layers to produce the processed video data stream transmitted to the playback device.

23. The system as in claim 19 further comprising:
a communication interface to communicate over a portion of the communication link between the video processor and the consumer-operated tuner system to notify the consumer-operated tuner system of a presence of the video processor in the communication link.

24. The system as in claim 19, wherein the communication interface receives a query from the consumer-operated tuner system, and, in response to the query, communicates over the communication link with the consumer-operated tuner system to notify the consumer-operated tuner system of a presence of the video processor in the communication link.

25. The system as in claim 19 further comprising:
a communication interface to receive a configuration notification from the consumer-operated tuner system, the configuration notification indicating a format type of the processed video data stream to be transmitted from the video processor to the playback device; and
a mode selector to program the video processor to process the received video data stream into the format type as specified by the configuration notification in response to the configuration notification.

26. The system as in claim 19 further comprising:
a communication interface to receive a command from the consumer-operated tuner system, the command indicating to operate the video processor in a pass-through mode in which the video data steram received from the consumer-operated tuner system is already processed for playback by the playback device; and
a mode selector, in response to the command, configured to set the video processor to receive the video data stream from the consumer-operated tuner system and transmit the received video data stream to the playback device without further processing by the video processor.

27. The system as in claim 19, wherein the consumer-operated tuner system resides in a consumer environment in which a respective consumer operates the consumer-operated tuner system to select the video data stream for playback by the playback device; and
wherein the video processor is a supplemental video processor disposed at an external location with respect to the consumer-operated tuner system, the video processor disposed in the communication link providing higher quality video processing than a quality of video processing supported by the consumer-operated tuner system.

28. The system as in claim 19, wherein the video processor receives auxiliary data from the consumer-operated tuner system in addition to receiving the video data stream, the auxiliary data representing graphics originated by the consumer-operated tuner system;
wherein the video processor combines the auxiliary data and the processed video data to produce the processed video data stream output to the playback device.

29. The system as in claim 19, wherein the enhanced video processing services includes at least one decoding service that produces a video signal for rendering higher resolution images than any of the decoding services supported by the consumer-operated tuner system.

30. A consumer-operated tuner system comprising:
an input;
a tuner to select content for playback on a playback device, the content received at the input being received as compressed video data transmitted from a server; and
an output to transmit the compressed video data to a downstream video processor disposed in a communication link between the consumer-operated tuner system and the playback device, the downstream video processor in the communication link providing enhanced video processing services with respect to video processing services provided by the consumer-operated tuner system.

31. The consumer-operated tuner system as in claim 30 further comprising:
a video processor to decode the compressed video data received from the server; and
a mode selector to switch between:
i) a first mode in which the consumer-operated tuner system transmits the compressed video data for decoding by the downstream video decoder, and
ii) a second mode in which the video processor in the consumer-operated tuner system decodes the compressed video data into a playback signal that is passed through the downstream video processor without further video decoding to the playback device for playback.

32. The consumer-operated tuner system as in claim 31, wherein the downstream video processor in the first mode produces a video signal for rendering higher resolution images than a resolution of images produced by decoding of the compressed video data by the consumer-operated tuner system in the second mode.

33. The consumer-operated tuner system as in claim 30, wherein the output transmits a compressed base layer from the consumer-operated tuner system to the downstream video decoder, the base layer supporting a first playback quality on the playback device; and
wherein the output transmits, to the downstream video decoder, one or more enhanced layers associated with the base layer, a combination of the base layer and the enhanced layers supporting one or more playback qualities on the playback device, each playback quality being better than the first playback quality.

34. The method as in claim 1, wherein enhanced video processing services provided by the video processor produce a processed video data stream having a higher refresh frame rate than a refresh frame rate supported by video processing services in the consumer-operated tuner system.

35. The method as in claim 1, wherein enhanced video processing services provided by the video processor produce a processed video data stream having a higher signal to noise ratio than a signal to noise ratio supported by video processing services in the consumer-operated tuner system.

36. The method as in claim 1, wherein the video processor provides enhanced color quality processing services with respect color quality services provided by video processing services in the consumer-operated tuner system.

37. The method as in claim 1, wherein the video processor provides 3-dimensional processing services that are not supported by the consumer-operated tuner system.

38. The method as in claim 1 further comprising:
receiving, at the video processor, a video data stream from an Internet connection in addition to receiving a video data stream from the consumer-operated tuner system; and
processing the video data stream received from the Internet connection to produce images for display on the playback device.
